(19) United States
(12) Patent Application Publication
(10) Pub. No.: US 2019/0092509 A1
(43) Pub. Date: Mar. 28, 2019

(54) METHOD FOR MANUFACTURING A PACKAGE FOR DAIRY PRODUCTS AND PACKAGE FOR DAIRY PRODUCTS THUS MANUFACTURED

(71) Applicant: Egidio Galbani S.r.l., Milano (IT)

(72) Inventor: Carla SILVA, Milano (IT)

(21) Appl. No.: 16/098,565

(22) PCT Filed: May 4, 2017
(86) PCT No.: PCT/EP2017/060729

§ 371 Date: Nov. 2, 2018

(30) Foreign Application Priority Data
May 5, 2016 (IT) 102016000046545

(51) Int. Cl. B65B 61/02; B65D 65/40; B65D 75/12; B65B 9/08; B32B 27/36; B32B 27/32; B32B 27/08

(52) U.S. Cl. CPC B65B 61/025; B65D 65/40; B65D 75/12; B65B 9/08; B32B 2439/70; B32B 27/32; B32B 27/08; B32B 2307/75; B32B 2307/31; B32B 27/36

(57) ABSTRACT

Method for manufacturing a package for dairy products, in particular for dairy products with preserving liquid, including: printing a multi-layer film provided with at least one central area configured to receive areas or graphic elements according to any coverage or covering index whatsoever of the color(s), at least two transverse edges and two longitudinal edges, at least one of said transverse edges and/or said longitudinal edges printed areas are achieved with one or more colors having a total coverage index of the color(s) comprised between 10% and 150%; and sealing said longitudinal edges and said transverse edges in a manner such as to obtain a package for dairy products in which said longitudinal edges and said transverse edges have a strength preferably of at least 5N/15 mm.

### FIELD OF APPLICATION

The present invention relates to a method for manufacturing a package for dairy products, in particular for dairy products that, inside the package, are immersed in a preserving liquid, for example mozzarella or the like. The present invention relates also to a package for dairy products manufactured with this method.

### STATE OF THE ART

It is known that common packages for dairy products with preserving liquid are made up of a multi-layer film comprising two or more film layers, usually plastic layers, joined by means of suitable adhesion processes. One of the two layers is usually made of polyethylene and is sealable, a feature that is indispensable for the production of the finished package that is obtained by sealing the edges of the package itself. Sealing can occur, for instance, by means of heat sealing or by another common technique.

Graphic elements such as logos, drawings, signs, colorings or the like are further impressed through printing on common packages of dairy products with preserving liquid, so that the package is immediately recognizable and so that information relating to the characteristics of the dairy product contained is reproduced on the package. According to the regulations in force, ink or inks used for printing must not come in contact with the product contained in the package or with its preserving liquid, so that the process of printing the graphic elements is completed by means of a so-called “reverse” rotogravure or flexographic printing technique. According to this printing technique, basically, one of the two or more films used to manufacture the multi-layer film is printed only on the inner side, in such a manner that, once they are coupled, they reciprocally trap the ink or inks for obtaining the graphic elements.

A drawback of common packages of dairy products with preserving liquid is that the presence of ink can seriously limit the strength of the sealing along the edges of the package, and for this reason these edges are left without any color. It is evident that the strength of the sealings of these packages is of vital importance for the correct preservation of the product and, of course, to avoid undesired leakages of preserving liquid.

This drawback is even more accentuated if the production speed of dairy product packages is higher, because the higher the production speed of dairy product packages, the lesser the time available for the sealing means, and the higher the temperatures and the pressures, with a consequent stress of the multi-layer film, to carry out a correct sealing of the edges.

In some manufacturing processes of dairy product packages these speeds can, in fact, reach 100 packages a minute and more.

Other limitations and drawbacks of conventional solutions and technologies will become evident to a person of skill in the art after reading the remaining part of the present specification with reference to the drawings and to the description of the forms of embodiment that follow, even though it is understood that the description of the state of the art related to the present specification shall not be considered an admission that what is described here is already known from the prior state of the art.

Therefore, there exists the need to develop a method for producing dairy products and for manufacturing a package for dairy products that can overcome at least one of the drawbacks of the known techniques.

An object of the present invention is, therefore, to develop a method for manufacturing a package for dairy products that allows to carry out printing of pigmented parts or graphic elements of any kind on the transverse and/or longitudinal edges of the package, which will be subject to sealing, while keeping an optimum strength of the package.

A further object of the present invention is to develop a method for manufacturing a package for dairy products that allows to obtain a package with printed edges that are suitable to be sealed, in which package the strength of the sealing is guaranteed also for high production speeds of packages for dairy products with preserving liquid.

A still further object of the present invention is to manufacture a package for dairy products, in particular for dairy products with preserving liquid, in which the sealed edges have an optimum strength, also in the presence of pigmented parts or graphic elements of any kind printed on the sealed edges.

A further object is, therefore, to manufacture a package for dairy products, in particular for dairy products with preserving liquid, that is immediately recognizable and that has also qualities of aesthetic value thanks to the presence of pigmented parts or graphic elements on the sealing edges.

To overcome the shortcomings of the prior art and to achieve these as well as other objects and advantages, the Applicant studied, experimented and realized the present invention.

### EXPOSITION OF THE INVENTION

The present invention is set out and characterized in the independent claims. The dependent claims expound other features of the present invention or variants to the main idea of solution.

In accordance with the above-mentioned objects and according to a first aspect of the invention, a method for manufacturing a package for dairy products, in particular for dairy products with preserving liquid, comprises: printing a multi-layer film provided with at least one central area configured to receive printed areas or graphic elements according to any coverage or covering index whatsoever of the color or colors, at least two transverse edges and two longitudinal edges; on at least one of said transverse edges and/or said longitudinal edges printed areas are achieved with one or more colors having a total coverage or covering index of the color or colors comprised between 10% and 150%; and sealing said longitudinal edges and said transverse edges in a manner such as to obtain a package for dairy products in which said longitudinal edges and said transverse edges have a strength preferably of at least 5N/15 mm.

Here and in the continuation of the description and in the claims, with the term “coverage” or “covering index” basically the surface or area is understood that is printed by any printing means whatsoever, for instance by a printing cylinder, i.e. the quantity of ink that it lays on the support.

Coverage can, hence, also be defined as the printing area or surface covered by ink.

In case of more than one printing means, for example in case of several printing cylinders, said coverage will be the surface or printing area of each printing cylinder.

Therefore, coverage shall not be confused with the parameter relating to opacity, which cannot be higher than 100%.

Coverage is usually expressed in percentage and total coverage is the summation of the coverages of the single colors, if there is more than one. In case of a summation of coverages, hence, the result can be higher than 100%.

By way of a non-limiting example, coverage referred to the surface unit can vary, for a single color/printing element, from 20% to 100%; this is the reason why coverage of inks can be higher than 100%, if there is an overlap in the laying of said inks.

Preferably, in forms of embodiment said value of total coverage or total covering index is equal to or lower than about 50%.

According to a further aspect of the invention, the ratio between printed areas and colorless areas or areas without ink in said longitudinal edges and/or in said transverse edges subject to sealing is comprised between 30% and 60%.

The distribution of printed areas and colorless areas or areas without ink obtained in a specific printing area of said transverse edges and/or of said longitudinal edges is, preferably, such as to comply with said coverage or covering index comprised between 10% and 150% and/or said ratio between printed areas and colorless areas or areas without ink comprised between 30% and 60%.

According to a further aspect of the invention, through said step of printing at least one of the longitudinal edges and/or of the transverse edges an alternation between printed areas and colorless areas or areas without ink is obtained which is suitable to allow for a correct production of packages on the production lines.

Preferably, printing of the multi-layer film with such values of total coverage is carried out by rotogravure or flexographic technique.

According to a further aspect of the invention, printing of the film is followed by a step of folding the film in a manner such as to give it a substantially tubular shape, by the sealing of the longitudinal edges and hence by the sealing of the transverse edges.

A further subject-matter of the invention is a package for dairy products, in particular for dairy products with preserving liquid, achieved by a manufacturing method as described above.

These and other aspects, features and advantages of the present disclosure will be better appreciated with reference to the following description, to the accompanying drawings and to the appended claims. The accompanying drawings, which are integrated into and which form part of the present description, illustrate some forms of embodiment of the present subject-matter and, together with the description, intend to describe the principles of the disclosure.

The various aspects and features described in the present specification can be applied individually, where possible. These individual aspects, for instance aspects and features contained in the description or in the appended dependent claims, can be the object of divisional applications.

It shall be noted that any aspect or feature that is found out to be already known during the patenting procedure is meant to be not claimed and is subject to a disclaimer.

### ILLUSTRATION OF THE DRAWINGS

These and other features of the present invention will be clear from the following description of forms of embodiment, provided by way of a non-limiting example, with reference to the annexed drawings, in which:

FIG. 1 is a view from above of a multi-layer film suitable to manufacture a package for dairy products according to the present invention;

FIG. 2 is a front view of the package for dairy products according to the invention;

FIG. 3 is a rear view of the package for dairy products according to the invention;

FIG. 4 is an enlarged view of a printed area made on one longitudinal sealing edge of the present package;

FIG. 5 is a view of a variant of a sealing edge for the present package for dairy products;

FIG. 6 is a schematic, cross-sectional, view of the present multi-layer film.

To facilitate understanding, identical reference numbers were used, where possible, to identify identical common elements in the figures. It shall be understood that elements and features of a form of embodiment can be suitably incorporated in other forms of embodiment without any further specifications.

### DESCRIPTION OF FORMS OF EMBODIMENT

Reference will be now made in detail to the various forms of embodiment of the invention, of which one or more examples are illustrated in the appended drawings. Each example is provided as an illustration of the invention and is not meant as a limitation of the same. For example, the features illustrated or described as being part of a form of embodiment can be adopted on, or in conjunction with, other forms of embodiment to produce a further form of embodiment. It is understood that the present invention comprises said modifications and variants.

Before describing the forms of embodiment, it is further clarified that the present description is not limited, in its application, to the details of construction and arrangement of the components as described in the following description using the appended figures. The present description can provide other forms of embodiment and be realized or put into practice in other different manners. Furthermore, it is made clear that the phraseology and terminology used here have descriptive purposes and shall not be considered limiting.

With reference to the appended drawings, with 10 a multi-layer film is designated which is suitable to obtain a package 20 for dairy products immersed in their own preserving liquid.

Said film 10 is formed, as stated above, by means of printing the inner or outer side used for the formation of the multi-layer film, so that the ink remains trapped inside the film 10 and so as to prevent said ink from coming in contact with the product to be packaged.

Said film 10 comprises a central area 11 in which graphic elements and pigmented parts of any color whatsoever and with any degree of coverage or covering index can be inserted.

Said film 10 comprises also, on two opposite sides, two transverse edges 12, i.e. directed substantially in T direction, which comprise printed areas 13, with graphic elements of any type, and colorless areas or areas without ink 14.

The film 10 is completed on each side by two longitudinal edges 15 and 16, i.e. directed substantially in L direction, of which at least one, for instance the longitudinal edge 15, comprises printed areas 17, alternating with colorless areas or areas without ink 18.

Considering, for instance, the printed areas 13 of the transverse edges 12, it can be assumed that they were obtained using one or more colors, having a predetermined coverage or covering index.

By way of example, observing the printed area Z of FIG. 2 and assuming that these printed areas 13 provide a first color with high covering power, for example dark blue, and a second color with lower covering power, for example cyan, it is possible to obtain printed areas 13 having a coverage or covering index of the first color corresponding to about 70% and a coverage or covering index of the second color corresponding to 85%, since the second color has a lower covering power, and therefore can be applied in a greater amount on the printed areas 13.

In this exemplary case, the coverage calculated on the whole longitudinal sealing edge would preferably correspond to about 15% for the first color with higher covering power and to about 20% for the second color with lower covering power.

The coverage or covering index, hence, varies depending on the color or colors used, if there are more than one, and must be comprised within suitable ranges, both in relation to a specific printed area Z and in relation to the whole transverse sealing edge 12, so as to guarantee the strength of the sealing to which the transverse edges 12 will be subjected in order to close the package 20.

The same applies also to the longitudinal edge 15, in which printed areas 17 are made that, depending on the colors used and applied, will have coverage values comprised within suitable ranges.

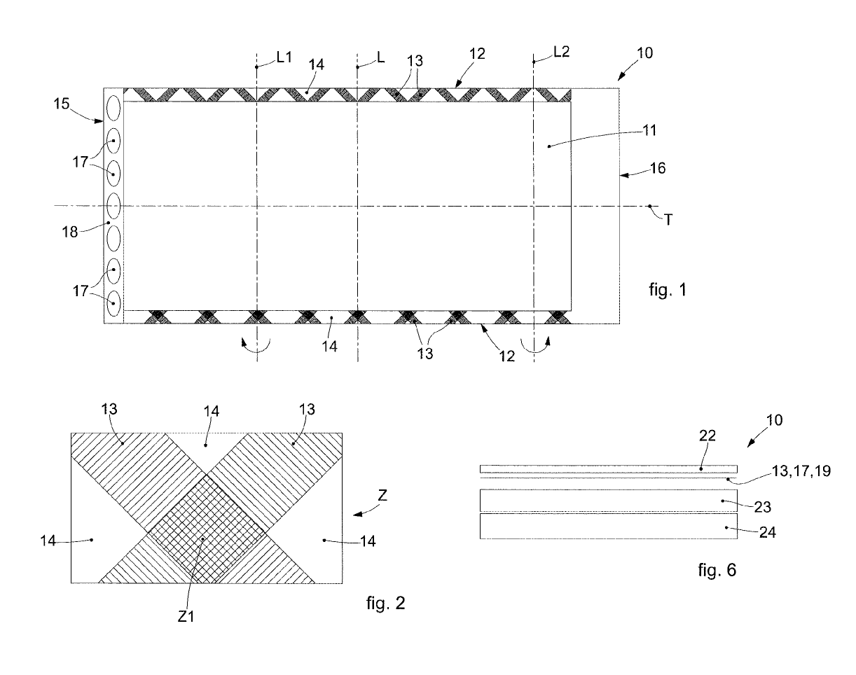

Generalizing what was shown in the example illustrated in FIG. 1, the Applicant surprisingly found, through suitable experimentations, that by using values of total coverage or total covering index of the ink or inks comprised between 10% and 150%, and preferably equal to or lower than about 50%, in order to make the printed areas 13, a strength of the scalings of said transverse edges 12 and of said longitudinal edges 15 and 16 is guaranteed that is equal to at least 5N/15 mm.

Said sealing strength value is determined on a segment of the transverse edge 12 and/or of the longitudinal edge 15, 16 corresponding to about 15 mm. Said strength value is established according to the standard for determining the seal strength known with the denomination ASTM F88-85 Giflex no. 3 or equivalents.

Said sealing strength value is guaranteed in whatever condition the packages 20 are, for example also when they are subject to pressures due to reciprocal contact when they are contained in containers or the like, and whatever the type of ink or inks used.

The minimum value of the above-mentioned range of total coverage guarantees a sufficient graphic performance, while the maximum value of said total coverage value guarantees the desired sealing strength.

Through said values of total coverage, that is to say a coverage that is valid for the whole sealing edge, whether longitudinal and/or transverse, a strength of the seals of said transverse edges 12 and of said longitudinal edges 15 and 16 is guaranteed that is equal to at least 5N/15 mm, in whatever condition the packages 20 are, for example when they are subject to pressures due to reciprocal contact when they are contained in containers or the like, and whatever the type of ink or inks used.

Another parameter that was considered, and that turned out to be important to guarantee an even more efficient and uniform strength of the transverse edges 12, but also of the transverse edges which contain printed areas, for instance the longitudinal edge 15, is the ratio between printed areas 13 and colorless areas or areas without ink 14, which must be comprised between 10% and 60%.

Furthermore, it was found that the distribution of printed areas 13 and of colorless areas must comply with suitable parameters, see for instance FIG. 2 in a bigger scale and relating to a print area Z of the transverse edge 12 comprising printed areas 13, in particular the distribution of printed areas 13 in relation to colorless areas or areas without ink 14 will have to comply both with said percentages of coverage comprised between 10% and 150% and/or with said ratio between printed areas and colored areas between 10% and 60%.

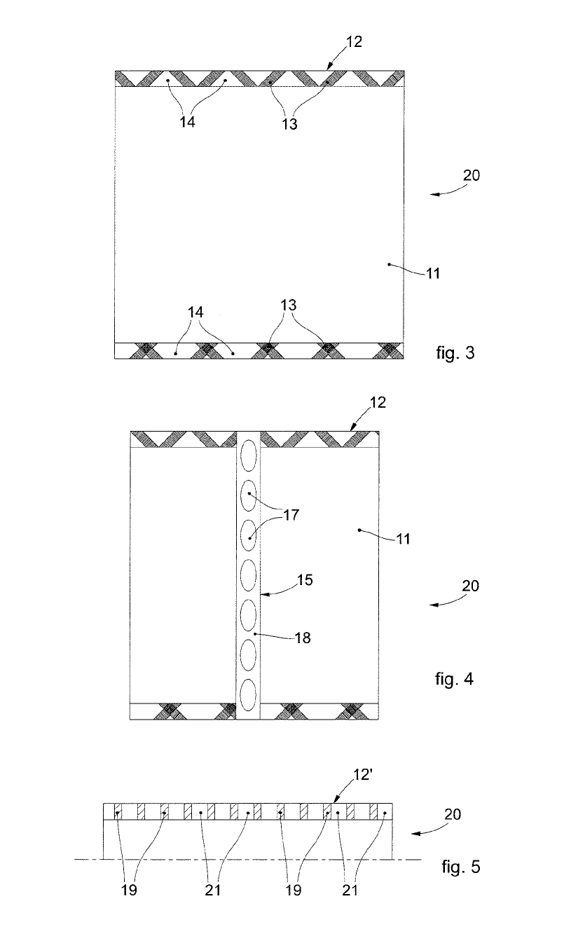

In FIG. 3 and in FIG. 4 the package 20, closed and containing the dairy product inside, immersed in its preserving liquid, for example mozzarella, is shown in the front and in the rear.

FIG. 5 shows one of the several variants that can be provided to manufacture, for instance, a different transverse edge 12′ with different printed areas 19, alternating with colorless areas or areas without ink 21.

Also in this case, the total coverage on the whole edge to be sealed, in this case the transverse edge 12′, must have values comprised between 10% and 150% and preferably equal or lower than 50%. Said values of total coverage will be provided on the longitudinal edges 15 and/or 16 too.

To guarantee an even better uniformity of the strength of the sealing on said transverse edge 12′—as seen before for the transverse edge 12—the ratio between printed areas 19 and colorless areas or areas without ink 21 must be comprised between 10% and 60%.

Of course, the transverse edges 12 and 12′ and the longitudinal edges 15 or 16 can have various forms and distributions of printed areas 13, 17, 19 as long as a minimum strength of said longitudinal and/or transverse edges, which will be subject to a subsequent sealing, of at least 5N/15 mm is always guaranteed. Said strength value is referred to a longitudinal and/or transverse edge having a width of about 15 mm.

The method for manufacturing the package provides, after the step of printing the central area 11 and the transverse edges 12 or 12′ and possibly also the longitudinal edge 15, according to what was explained above, a step of folding the film 10, carried out schematically around the axes L1 and L2 in a manner such as to give it a substantially tubular shape.

Said folding is followed by a longitudinal sealing of the longitudinal edges 15 and 16 and hence, after the dairy product has been inserted inside the package, sealing of the lower transverse edge 12 and then of the upper transverse edge 12 is carried out. In actual fact, in consideration of the speed with which the packages are manufactured, which—as already said—can be of 100 packages a minute and more, sealing of the transverse edges 12 occurs substantially simultaneously.

As we said above, thanks to the step of printing the transverse edges 12 or 12′ and the longitudinal edges 15 and/or 16 according to the values of total coverage indicated above, it is possible to obtain packages for dairy products which have an optimum strength in the sealing areas, regardless of the conditions of manufacturing and storage of said packages.

FIG. 6 illustrates schematically and in cross section the film 10 according to the invention, comprising in particular three layers 22, 23, 24 and the printed area, for example the printed area 13, 17 or 19.

By way of example, and for a better clarity of illustration, said layers 22, 23 and 24 and the printed area are illustrated as being separate from one another but, of course, in the final film 10, they will be reciprocally adjacent.

Furthermore, the thicknesses illustrated for said layers 22, 23, 24 and for the printed area 13 are purely exemplary and not restrictive.

To make the printed areas 13, 17 and/or 19 of the present film 10, in forms of embodiment of the invention “reverse” rotogravure printing is used.

For example, a suitably pre-engraved printing cylinder can be used to transfer ink, having a suitable viscosity, directly on the inner surface of the printing layer 22, so as to obtain the printed area 13, 17 or 19.

Basically, then, the layer 22 represents the outside part of the film 10 and is printed internally, in a manner such that the layer 22 itself acts as a protection from and towards the printed area 13, 17 or 19.

If more colors are used to make the printed area 13, 17 or 19, more printing cylinders will be used, each of which lays a specific color on the layer 22.

To obtain the desired final printed area, the different colors that are necessary to achieve the final result, for example the printed areas 13, 17 or 19, will be printed in sequence.

For instance, in case of use of a flexographic machine for laying the color or colors, so as to obtain the printed area 13, 17 or 19, said machine will usually be provided with an inking unit, provided with a printing cylinder for each specific color.

Also in case of use of a flexographic machine, then, the final result will be the outcome of the sequence or overlapping of different colors. In case of overlapping of colors—as was said before—the value of total coverage of the colors on the printed area can be higher than 100%.

As we said, for example in the area Z of FIG. 2 two printed areas 13 can be provided that are obtained with colors having different or equal percentages of coverage, and in the central area Z1 of color overlapping, the total coverage can be higher than 100%, if each of said colors has a coverage that is higher than 50%.

The layer 22, or the printing support, can be made in a material such as nylon or the like.

The layer 23 is an intermediate sealing layer and can be made for instance of cast polyethylene or the like.

The layer 24 is an inner sealing layer, in direct contact with the product, and can be made for example of extruded heat-sealable polyethylene or the like.

The total thickness of the film 10 can be comprised for example between about 70 μm and about 80 μm. The structure of the film 10 illustrated in FIG. 6 guarantees a great resistance and at the same time lightness of the package obtained, beside a valuable aesthetic aspect.

It is evident that modifications and/or additions of parts can be made to the present method for manufacturing a package for dairy products and to the package for dairy products thus manufactured described heretofore, without, for this, departing from the scope of the present invention.

It is also evident that, even though the present invention was described with reference to some specific examples, a person of skill in the art will be readily able to achieve other equivalent forms of the method for manufacturing a package for dairy products and of the package for dairy products thus manufactured having the features set out in the claims and, hence, all of them falling within the scope of protection defined by the claims.

In the claims that follow, the aim of the reference numbers in parentheses is only that of facilitating reading and they must not be considered as limiting factors as regards the field of protection underlying the specific claims.

1. A method for manufacturing a package (20) for dairy products, in particular for dairy products with preserving liquid, wherein it comprises: printing a multi-layer film (10) provided with at least one central area (11) configured to receive areas or graphic elements according to any coverage or covering index whatsoever of the color or colors, at least two transverse edges (12, 12′) and two longitudinal edges (15, 16), wherein on at least one of said transverse edges (12, 12′) and/or said longitudinal edges (15, 16) printed areas (13, 17, 19) are achieved with one or more colors having a total coverage or total covering index of the color or colors comprised between 10% and 150%; and
sealing said longitudinal edges (15, 16) and said transverse edges (12, 12′) in a manner such as to obtain a package (20) for dairy products in which said longitudinal edges (15, 16) and said transverse edges (12, 12′) have a strength preferably of at least 5N/15 mm.

2. The method as in claim 1, wherein said value of total coverage or total covering index is equal to or lower than about 50%.

3. The method as in claim 1, wherein the ratio between printed areas (13, 17, 19) and colorless areas or areas without ink (14, 18, 21) in said longitudinal edges (15, 16) and/or in said transverse edges (12, 12′) subject to sealing is comprised between 10% and 60%.

4. The method as in claim 3, wherein the distribution of printed areas and colorless areas or areas without ink obtained in a specific area (Z) of said transverse edges (12, 12′) and/or of said longitudinal edges (15, 16) is such as to comply with said total coverage or total covering index comprised between 10% and 150% and/or said ratio between printed areas (13, 17, 19) and colorless areas or areas without ink (14, 18, 21) comprised between 10% and 60%.

5. The method as in claim 1, wherein through said step of printing at least one of the longitudinal edges (15, 16) and/or of the transverse edges (12, 12′) an alternation between printed areas (13, 17, 19) and colorless areas or areas without ink (14, 18, 21) is obtained which is suitable to allow for a correct production of packages on the production lines.

6. The method as in claim 1, wherein said printing of the multi-layer film (10) with said coverage values is carried out by rotogravure or flexographic technique.

7. The method as in claim 1, wherein said printing of the film (10) is followed by a step of folding the film (10) in a manner such as to give it a substantially tubular shape, by the sealing of the longitudinal edges (15, 16) and by the sealing of the transverse edges (12, 12′).

8. A package for dairy products, in particular for dairy products with preserving liquid, obtained by a manufacturing method as in claim 1.

9. The package as in claim 8, wherein it comprises the film (10) which is provided with at least one outer layer (22), the inner surface of which acts as a support for said printed areas (13, 17, 19), with at least one intermediate sealing layer (23) and with at least one inner sealing layer (24).

10. The package as in claim 9, wherein said film (10) has a thickness comprised between about 70 μm and about 80 μm.
